(19) United States
(12) Patent Application Publication
(10) Pub. No.: US 2008/0271138 A1
(43) Pub. Date: Oct. 30, 2008

(54) SYSTEM AND METHOD FOR OPTIMIZING DATA OVER SIGNALING TRANSMISSIONS

(75) Inventors: Shunlin Chen, Shenzhen (CN); Sha Lv, Shenzhen (CN); Mintao Dai, Shenzhen (CN)

Correspondence Address: AKIN GUMP STRAUSS HAUER & FELD, LLP, P O BOX 688, DALLAS, TX, 75313-0688, US

(73) Assignee: HUAWEI TECHNOLOGIES CO., LTD., Shenzhen (CN)

(21) Appl. No.: 11/740,593

(22) Filed: Apr. 26, 2007

(51) Int. Cl. H04L 9/32

(52) U.S. Cl. 726/17

(57) ABSTRACT

A system for optimizing data over signaling (DoS) transmissions in wireless communications system is disclosed. The system comprises at least one access network and at least one access terminal. The at least one access network is adapted to determine location of the at least one access terminal through communication between the at least one access network and the at least one access terminal, and adapted to transfer data between the at least one access network and the at least one access terminal.

### TECHNICAL FIELD OF THE INVENTION

The present invention relates generally to wireless communications, and more particularly, to a versatile system and methods for optimizing data over signaling transmissions in a CDMA2000 1xEV-DO environment.

### BACKGROUND OF THE INVENTION

Recent revisions of the 1xEV-DO standard provide a Data over Signaling (DoS) protocol, by which data may be transmitted over a Control Channel or an Access Channel, thereby increasing data communication flexibility. When small amounts of data are sent over a Control Channel or an Access Channel, the need to establish a connection is eliminated, thus conserving air interface resources and improving the ability to communicate data in real time.

In addition, DoS protocol provides a DataoverSignaling message to carry upper-layer data, and a DataoverSignalingAck message as a response. By utilizing DataoverSignaling and DataoverSignalingAck messages, forward data as well as reverse data can be transmitted.

FIG. 1 is a diagram illustrating a conventional method for transmitting data in DoS format over a Control Channel. When a Packet Data Serving Node (PDSN) (108) has packet data destined for an Access Terminal (AT) (102), PDSN (108) sends the packet data to a Packet Control Function (PCF) entity (106). There is no traffic connection between PCF (106) and AT (102). Thus, PCF (106) sends the packet data to an Access Network (AN) (104) in an A9-Short Data Delivery message. If AT (102) is in a dormant state or an idle state, then the AN (104) sends a DataoverSignaling message throughout the range of an entire subnet where AT (102) is being served. Then, AT (102) sends a DataoverSignalingAck message to AN (104) indicating the DataoverSignaling message was received. AN (104) then sends an A9-Short Data Delivery Ack message to PCF (106) indicating delivery of the data to AT (102) in the DoS format.

In this scheme, AN (104) only has knowledge of the subnet where AT (102) is in, but does not know which cell or sector of the subnet AT (102) is located. Therefore, the DataoverSignaling message is sent throughout the entire subnet. If SecondaryColorCode feature is supported in the network, then the DataoverSignaling message also needs to be sent to subnets having a ColorCode value included in the SecondaryColorCode. Thus, a DoS message may need to be sent throughout a very large area. Furthermore, since DataoverSignaling messages are used to transmit data, a large amount of data may be involved in a DataoverSignaling message. Thus sending a message having a large amount of data, throughout a large area, places a very high demand for system processing capability, forward resources and air interface resources.

Therefore, there is a need for more efficient and optimal methods of DoS transmission that reduce the demand on system resources and processing capabilities. There is a further need for efficient and optimal methods of DoS transmission that improve transmitted data reliability.

### SUMMARY OF THE INVENTION

Structure and methods for optimizing data over signaling transmissions in a CDMA2000 1xEV-DO environment is provided. DataoverSignaling messages are sent only to a serving cell or a sector for an Access Terminal (AT). Thus, impact on the network caused by sending large amounts of data is minimized, and reliability of data transmitted over the DoS protocol is optimized.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a PRIOR ART method of signaling;

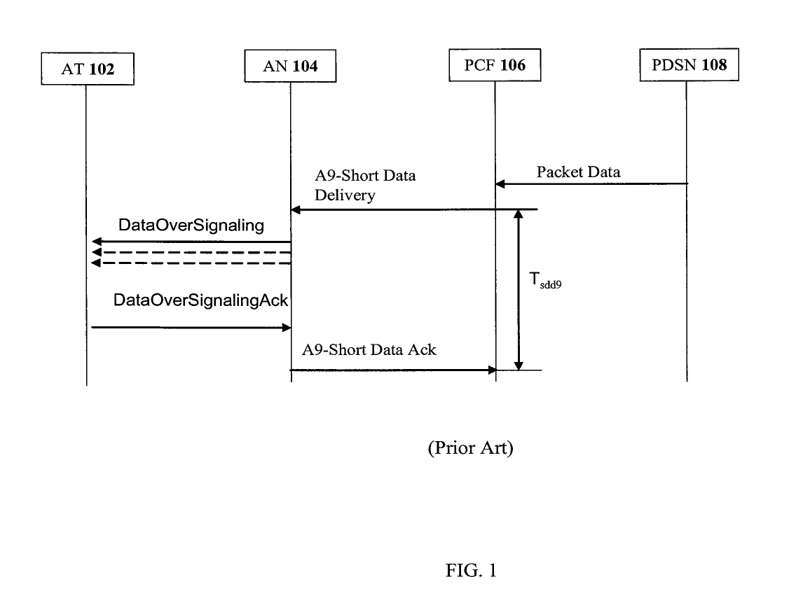

FIG. 2 is a diagram illustrating signaling according to one embodiment of the present invention;

FIG. 3 is a diagram illustrating signaling according to another embodiment of the present invention; and

FIG. 4 is a diagram illustrating signaling according to yet another embodiment of the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

System for optimizing Data over Signaling (DoS) transmissions in a CDMA2000 1xEV-DO environment is provided. In the embodiments of the present invention, DataoverSignaling messages are only sent to the serving cell or the sector for an Access Terminal (AT). Thus impact on the network caused by sending large amount of data is reduced to the minimum, and reliability of data transmitted over the DoS protocol is further improved.

The embodiments of the present invention provide methods to send DoS messages over a Control Channel (CC) to an AT when the AT is in a dormant state or an idle state. The methods of the embodiments of the present invention may: determine a DoS message delivery method (optional); locate a serving cell or a sector for the AT; and send DoS messages to the designated serving cell or sector.

Moreover, an Access Network (AN) may specify a given threshold value for determining which method is to be used for DoS message delivery. If the received packet data is greater than the given threshold—that is, a large amount of data needs to be delivered to an AT—then a serving cell or sector for the AT is determined before sending the DoS messages. If the received packed data is small, then conventional methods are used to send the DoS messages. This threshold may be determined or defined, dynamically or statically, by the AN itself; or it may be desirable to provide it having a pre-defined length on the order of a paging message.

When a serving cell or sector for an AT needs to be determined before DoS messages are sent from an AN, the AN needs to obtain the location of the AT. The location of the AT may be obtained through communications between the AN and the AT. For example, the AN may send a message to the AT for locating purposes, and obtain AT's location after receiving a response from the AT. In this case, several methods may be employed. A first method uses additional messages to locate an AT before the DoS messages are delivered. A locating message may be any message that an AT may respond in an Access Channel (AC), such as a paging message, a RouteUpdateRequest message, or other messages. A second method uses a DoS message for locating purposes. An AN may send large data packet using multiple DoS messages. In this case, the first DoS message may be directly used to locate an AT. That is, an AN broadcasts the first DoS message throughout the subnet, and once the AN receives a corresponding DataoverSignalingAck message, the AT's location information is obtained. Subsequent DataoverSignaling messages are then sent to the AT according to the location information.

When an AN has DoS messages to deliver to an AT, it determines whether an AT needs to be located first, according to the amount of data to be delivered. When the AT is located, data may then be sent to the determined location of the AT.

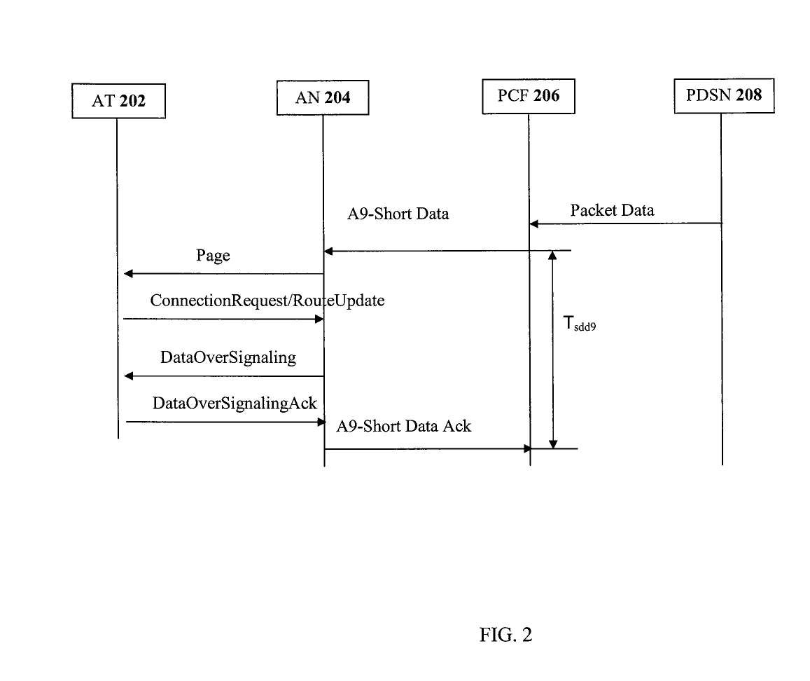

Referring now to FIG. 2, an embodiment for delivering a DoS message from an AN (204) to an Access Terminal (AT) (202) after locating AT (202) is illustrated. In this embodiment, a paging message is used to locate AT (202).

In this example, a Packet Data Serving Node (PDSN) (208) has packet data destined for AT (202), so, PDSN (208) sends the packet data to a Packet Control Function (PCF) entity (206). There is no traffic connection between PCF (206) and AT (202) at this time. Accordingly, PCF (206) sends the packet data to AN (204) in an A9-Short Data Delivery message. If AT (202) is in a dormant state or an idle state, AN (204) sends a paging message to page AT (202), initiating a call connection. AT (202) then sends a ConnectionRequest message or a RouteUpdate message to AN (204), requesting call connection initiation, and reporting the current location of AT (202). AN (204) then locates AT (202) based on the RouteUpdate message, and sends a DoS message to AT (202). AT (202) then sends DataoverSignalingAck indicating that the DoS message was received. AN (204) then sends A9-Short Data Delivery Ack message to PCF (206) indicating data delivery.

The above embodiment uses a paging message to locate an AT. However, an AT, receiving a paging message, may only respond to the paging message for locating purposes. Thus, the AT does not need to initiate a call connection. For covering this scenario, a ConnectionIndication field may be added in a paging message, indicating whether an AT is initiating a call connection, as shown below in Table 1.

TABLE 1

| Field | Length (bits) |
|---|---|
| MessageID | 8 |
| ConnectionIndication | 8 |

If an AT is not expected to initiate a call connection when receiving a paging message, then the ConnectionIndication is set to 0. On the other hand, if an AT is expected to initiate a call connection, the ConnectionIndication is set to 1. Therefore, when an AN sends a paging message to an AT, and the ConnectionIndication is equal to 0, the AT only need respond with a RouteUpdate message to the AN, and does not initiate a call connection.

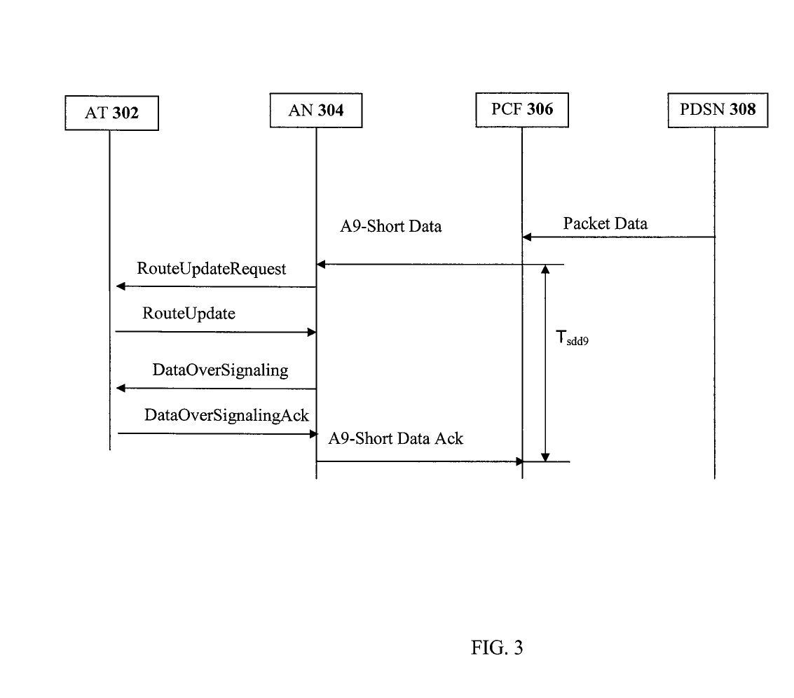

An alternative embodiment uses a RouteUpdateRequest message to locate an AT. FIG. 3 is a diagram of delivering a DoS message from an AN (304) to an AT (302) after locating the AT (302) using a RouteUpdateRequest message.

In this embodiment, a PDSN (308) has packet data destined for AT (302). Therefore, PDSN (308) first sends the packet data to a PCF (306). At this time, there is no traffic connection between PCF (306) and AT (302). Thus, PCF (306) sends the packet data to AN (304) in an A9-Short Data Delivery message. If AT (302) is in a dormant state or an idle state, AN (304) sends a RouteUpdateRequest message, instructing AT (302) to send a RouteUpdate message. AT (302) then sends a RouteUpdate message to AN (304), reporting the current location of AT (302). AN (304) locates AT (302) based on the RouteUpdate message, and send a DoS message to AT (302) at the corresponding location. AT (302) then sends a DataoverSignalingAck indicating the DoS message was received. AN (304) then sends a A9-Short Data Delivery Ack message to PCF (306) indicating data delivery.

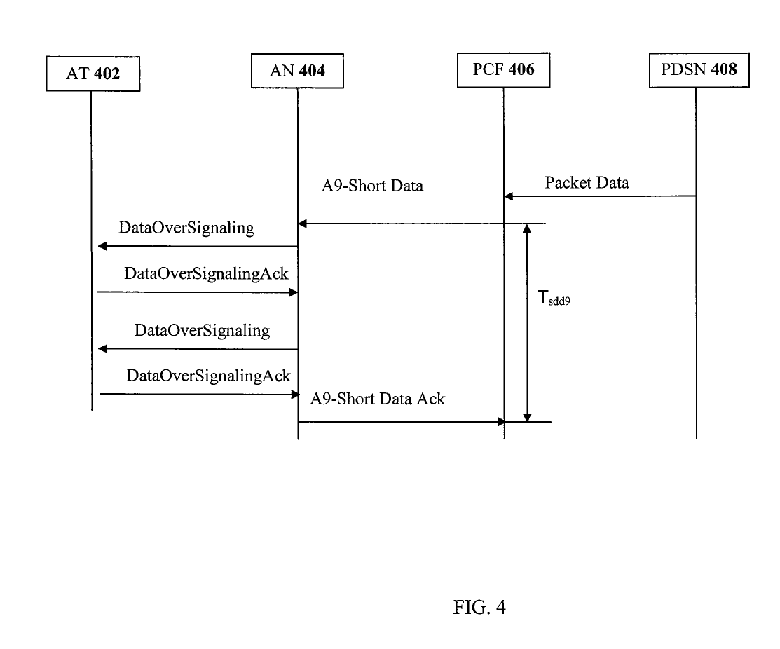

In another embodiment, an AN uses multiple DoS messages to deliver a data packet, and uses the first DoS message to locate an AT. FIG. 4 is a diagram of delivering DoS messages from an AN (404) to an AT (402) after locating AT (402) using a DoS message.

In this embodiment, a PDSN (408) has packet data destined for AT (402). Thus, PDSN (408) first sends the packet data to a PCF (406). At this time, there is no traffic connection between PCF (406) and AT (402). As a result, PCF (406) sends the packet data to AN (404) in an A9-Short Data Delivery message. If AT (402) is in a dormant state or an idle state, then AN (404) splits one DoS message up into two or more DoS messages, and sends the first DoS message. AT (402) then sends a DataoverSignalingAck message indicating the DoS message was received. AN (404) obtains the location of AT (402) based upon the DataoverSignalingAck message, and then sends the remaining DoS messages to this location. AT (402) then sends a DataoverSignalingAck messages indicating the DoS messages were received. In addition, AN (404) responds to PCF (406) with an A9-Short Data Ack message.

In summary, embodiments of the present invention obtain location information of an AT for an AN, before sending DoS messages to the AT. Thus, DoS messages are sent to the AT based on obtained location information, instead of sending messages throughout the entire subnet where the AT is. This greatly reduces demand for system performance and improves data delivery reliability.

Some advantages of at least one embodiment of the present invention may be shown by an analysis on data volume involved in sending a DoS message to an AT. In one example, an AN sends a DoS message to an AT, and the message is 200 bytes in length. If there are 100 cells in a subnet of the AN, then the total amount of data to be delivered within the subnet is: 100*200=20,000 bytes (headers are not considered in this analysis).

The AN may first locate the AT using a paging message, and then send the DoS message to the AT, as described in the embodiment above. The paging message, which includes 2 bytes, is first sent throughout the subnet. Thus, delivering the paging message involves a data amount of: 100*2=200 bytes.

Once the AT's location information is obtained, the AN sends the DoS message to the serving cell or sector of the AT, which consists of a data amount of: 1*200=200 bytes.

Therefore the total amount of data involved in delivering a DoS message to an AT by use of one embodiment, among others, of the present invention is: 200+200=400 bytes.

Comparatively, sending a DoS message using a conventional method requires delivering a data amount of 20,000 bytes. In contrast, the method in one embodiment, among others, of the present invention only requires 400 Bytes of data to be sent. Therefore, at least one embodiment, among others, of the present invention greatly reduces the amount of data to be delivered.

In addition, at least one embodiment, among others, of the present invention is also advantageous when a large DoS message needs to be delivered. If a DoS message is divided into multiple DoS messages for delivery, the first DoS message may be made as short as possible (e.g., 1 byte), to be used for locating an AT. The remaining DoS messages, containing effective data to be delivered, are then delivered within the serving cell or sector of the AT according to the location information. Thus, the amount of data to be delivered is decreased substantially.

However, this step for determining whether a DoS message is a large amount may be included or omitted as needed. An AN may make such a determination if desired. An AN may also set up a threshold for the determination. These options provide more flexibility for using one embodiment, among others, of the present invention.

The previous description of the disclosed embodiments is provided to enable those skilled in the art to make or use one embodiment, among others, of the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of transmitting data in a Data over Signaling message within a wireless network, comprising:
determining location of an access terminal through communication between an access network and the access terminal; and
transferring the data between the access network and the access terminal.

2. The method of claim 1 wherein determining location of an access terminal further comprises the access network sending a message to the access terminal for location purpose, and the access terminal responding to the access network.

3. The method of claim 2 wherein determining location of the access terminal within the wireless network comprises transmitting a paging message.

4. The method of claim 3 wherein when the access terminal receives the paging message, the access terminal initiates a call connection with the access network if a connection indicator is set to 1, or the access terminal does not initiate a call connection with, but only responses to, the access network if the connection indicator is set to 0.

5. The method of claim 2 wherein determining location of the access terminal within the wireless network comprises transmitting a route update message or a Data over Signaling message.

6. The method of claim 2 wherein determining location of the access terminal within the wireless network comprises:
splitting the Data over Signaling message into two or more Data over Signaling messages by the access network; and
sending a first Data over Signaling message of the two or more Data over Signaling messages to the access terminal by the access network.

7. The method of claim 6 wherein the first Data over Signaling message of the two or more Data over Signaling messages has a minimal length of bytes.

8. The method of claim 1 wherein transferring data between the access network and the access terminal is via a Control Channel or an Access Channel.

9. The method of claim 1 wherein the wireless network is a CDMA2000 1xEV-DO system.

10. The method of claim 1 wherein the access terminal is in a dormant state or an idle state.

11. The method of claim 1 wherein the step of determining location of an access terminal further comprises determining location of an access terminal when the amount of data exceeds a designated threshold.

12. A method of transmitting data in a Data over Signaling message within a wireless network, comprising:
identifying an amount of data to be transferred to an access terminal;
determining location of the access terminal if the amount of data to be transferred exceeds a threshold size; and
transferring data between an access network and the access terminal.

13. The method of claim 12 wherein determining location of the access terminal comprises transmitting a paging message.

14. The method of claim 13 wherein when the access terminal receives the paging message, the access terminal initiates a call connection with the access network if a connection indicator is set to 1, or the access terminal does not initiate a call connection with, but only responses to, the access network if the connection indicator is set to 0.

15. The method of claim 12 wherein determining location of the access terminal comprises transmitting a route update message or a Data over Signaling message.

16. The method of claim 12 wherein determining location of the access terminal comprises:
splitting the Data over Signaling message into two or more Data over Signaling messages by the access network; and
sending a first Data over Signaling message of the two or more Data over Signaling messages to the access terminal by the access network.

17. The method of claim 16 wherein the first Data over Signaling message of the two or more Data over Signaling messages has a minimal length of bytes.

18. The method of claim 12 wherein transferring data between the access network and the access terminal via a Control Channel or an Access Channel.

19. The method of claim 12 wherein the wireless network is a CDMA2000 1xEV-DO system.

20. The method of claim 12 wherein the access terminal is in a dormant state or an idle state.

21. A system for transmitting data in a Data over Signaling message within a wireless network, comprising:
at least one access network and at least one access terminal;
wherein the at least one access network is adapted to determine location of the at least one access terminal through communication between the at least one access network and the at least one access terminal, and adapted to transfer data between the at least one access network and the at least one access terminal.

22. The system of claim 21 wherein the at least one access network is adapted to determine location of the at least one access terminal if data to be transferred to the at least one access terminal exceeds a threshold size.
